(19) United States
(12) Patent Application Publication
(10) Pub. No.: US 2024/0344176 A1
(43) Pub. Date: Oct. 17, 2024

(54) RECOVERY OF VANADIUM FROM LEACH RESIDUES

(71) Applicant: AVANTI MATERIALS LTD, West Perth, Western Australia (AU)

(72) Inventor: David ROBINSON, West Perth, Western Australia (AU)

(21) Appl. No.: 18/577,542

(22) PCT Filed: Jun. 30, 2022
(86) PCT No.: PCT/AU2022/050677

§ 371 Date: Jan. 8, 2024

(30) Foreign Application Priority Data
Jul. 8, 2021 (AU) 2021902081

(51) Int. Cl. C22B 34/22; C22B 3/14; C22B 3/42; C22B 3/44

(52) U.S. Cl. CPC C22B 34/22; C22B 3/14; C22B 3/42; C22B 3/44

(57) ABSTRACT

The present invention relates to a method for the recovery of vanadium from a vanadium containing leach residue, the method comprising the steps of: subjecting the leach residue to a pulping step, the pulping step comprising the contact of the leach residue with an aqueous solution to produce a repulp slurry; passing the repulp slurry to a solid liquid separation step to produce a repulp solution containing vanadium and a repulp residue; and recovering vanadium from solution in an ion exchange step.

### TECHNICAL FIELD

The present invention relates to a method for the recovery of vanadium from residues produced from leach processes. More specifically, the method of the present invention is adapted to recover vanadium from leach residues that result from alkaline leach processes.

### BACKGROUND ART

The following discussion of the background art is intended to facilitate an understanding of the present invention only. The discussion is not an acknowledgement or admission that any of the material referred to is or was part of the common general knowledge as at the priority date of the application.

Vanadium is most prominently found within magnetite iron ore deposits and is typically present in slags generated during iron recovery processes. To extract or recover vanadium, the concentrates or slags are typically processed with the so-called ‘salt roast process’. In the salt roast process, the vanadium slag is mixed with one or more alkali salts and subjected to a roast typically at 800-900° C., to produce sodium metavanadate. These vanadium values are subsequently and selectively leached with water. Vanadium values are then recovered in a refining process that includes precipitation from the leach solution as ammonium metavanadate or ammonium polyvanadate, both of which can be treated at high temperature to de-ammoniate and convert to product vanadium pentoxide. The process and particularly the initial high temperature salt roast step is highly energy intensive and so the vanadium tenor in the feed needs to be at a particular level to make the process economical.

A number of alternative hydrometallurgical processes have been employed to process the slags for the recovery of vanadium. Such processes typically comprise an acid or alkaline leach step to extract vanadium into solution. Following the completion of the leach step, undissolved materials are separated from the vanadium containing solution by way of filtration, or other solid liquid separation techniques. One problem faced at this stage is the presence of entrained soluble species in the recovered solid. This results in diminished recoveries and is particularly problematic when leaching vanadium from sources with a low vanadium content. These losses can be reduced by washing the leach residue on the filter and recycling the wash liquid back to the leach step. However, typical wash efficiencies can be as low as 60-70% and so losses still occur.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with a first aspect of the present invention, there is provided a method for the recovery of vanadium from a vanadium containing leach residue, the method comprising the steps of:
subjecting the leach residue to a pulping step, the pulping step comprising the contact of the leach residue with an aqueous solution to produce a repulp slurry comprising a repulp solution containing vanadium and a repulp residue;
passing the repulp slurry to a solid liquid separation step to separate the repulp solution containing vanadium and the repulp residue; and
recovering vanadium from the repulp solution in an ion exchange step.

Preferably, the pulping step comprises agitation of the repulp slurry. The inventors have found that the agitation of the repulp slurry ensures separation of solid particles, mixing of entrained liquors and leach residue, and opportunity for dissolution of soluble species contained in the leach residue.

Preferably, the ion exchange step comprises contacting the repulp solution with an ion exchange resin to load vanadium onto the ion exchange resin.

In one form of the present invention, the ion exchange step is conducted following the solid liquid separation step. In this form of the invention, the separated repulp solution is contacted with the ion exchange resin.

In an alternative form of the present invention, the ion exchange step is conducted prior to the solid liquid separation step. In this form of the present invention, the repulp slurry is contacted with the ion exchange resin. Preferably, the loaded resin is recovered from the repulp slurry prior to the solid liquid separation step.

In one form of the present invention, the leach residue is subjected to a comminution step prior to the pulping step. The comminution step should be understood to refer to any physical process that acts to break up and separate the leach residue particles, for example a sizer or a macerator. The comminution step does not require the size reduction of the individual leach residue particles.

In one form of the present invention, the liquid:solid ratio in the pulping step is between 2:1 and 20:1. Preferably, the liquid:solid ratio in the pulping step is between 5:1 and 15:1. More preferably, the liquid:solid ratio in the pulping step is approximately 10:1.

In one form of the present invention, the liquid:solid ratio in the pulping step is at least 2:1. Preferably, the liquid:solid ratio in the pulping step is at least 3:1. Preferably, the liquid:solid ratio in the pulping step is at least 4:1. Preferably, the liquid:solid ratio in the pulping step is at least 5:1. Preferably, the liquid:solid ratio in the pulping step is at least 6:1. Preferably, the liquid:solid ratio in the pulping step is at least 7:1. Preferably, the liquid:solid ratio in the pulping step is at least 8:1. Preferably, the liquid:solid ratio in the pulping step is at least 9:1. Preferably, the liquid:solid ratio in the pulping step is at least 10:1.

In one form of the present invention, the pulping step is conducted in an agitated vessel.

In one form of the present invention, the pulping step is conducted in a heated vessel.

In one embodiment, the temperature of the aqueous solution is above ambient temperature. Preferably, the temperature of the aqueous solution is at least 60° C.

In one embodiment, one or more solution modifiers is added to the repulp step. Preferably, the solution modifiers are selected from pH modifiers and redox modifiers.

In one form of the present invention, the repulp slurry is directed to a magnetic separation step to produce a magnetic faction and a non-magnetic faction.

In one form of the present invention, the magnetic faction is directed to a solid liquid separation step to produce a repulp solution containing vanadium and a magnetic repulp residue.

In one form of the present invention, the non-magnetic faction is directed to a solid liquid separation step to produce a repulp solution containing vanadium and a non-magnetic repulp residue.

Preferably, the repulp solution recovered from the magnetic faction and the repulp solution recovered from the non-magnetic faction are recombined and passed to the ion exchange step.

In one form of the present invention, the repulp slurry is directed to a thickening step to produce a thickener overflow solution and a thickener underflow slurry. Preferably, the thickener overflow solution is directed back to the pulping step and the thickener underflow slurry is directed to the solid liquid separation step.

In one form of the present invention, the repulp residue is washed. Preferably, the wash solution, or part thereof, is combined with the separated repulp solution.

In one form of the present invention, the repulp solution is subjected to a pH conditioning step prior to the ion exchange step. Preferably, the pH conditioning step will reduce the pH of the repulp solution to less than 10. In one embodiment, the pH of the repulp solution is lowered using CO₂ gas.

In one form of the present invention, the ion exchange step further comprises recovering vanadium from the loaded ion exchange resin. Preferably, the loaded ion exchange resin is contacted with an eluent to produce a vanadium eluate solution.

In one form of the present invention, the effluent from the ion exchange step is directed to the pulping step.

In one form of the present invention at least a portion of the effluent from the ion exchange step is recycled to the leach step.

In one form of the present invention, the method comprises the step of recovering sodium from the repulp solution. The step of recovering sodium from the repulp solution may be conducted prior to or following the recovery of vanadium from the repulp solution

In one form of the present invention, the method further comprises the recovery of a vanadium product from the vanadium eluate solution.

In one form of the present invention, the step of recovering a vanadium product from the vanadium eluate solution comprises precipitating a vanadium rich solid and separating the vanadium rich solid from the barren solution. Throughout the specification, the term “barren solution” will be understood to refer to a solution to which at least a portion of the vanadium has been recovered. It should be understood to include a solution that contains vanadium.

In an alternative form of the present invention, the vanadium eluate solution is used as a stripping solution in a solvent extract process. It is envisaged that vanadium may be recovered from pregnant leach solutions in a solvent extraction circuit. In such a such a circuit, the pregnant leach solution is contacted with an organic extractant to selectively extract vanadium ions into the organic phase. The loaded organic phase can then be separated from the aqueous raffinate. A stripping agent is used to recover the vanadium from the loaded organic. It is envisaged that the vanadium eluate solution recovered in the present invention may be used to at least partially supplement the stripping agent. The vanadium ions in the vanadium eluate solution will then be introduced into the solvent extraction strip solution, allowing for subsequent recovery.

In one form of the present invention, the leach residue is obtained from a leach step comprising the contact of a vanadium containing feed stream with an alkaline carbonate leach solution. Throughout this specification, unless the context requires otherwise, the term “alkaline carbonate leach solution” or similar variations, will be understood to refer to an aqueous solution comprising a carbonate or bicarbonate of an alkali metal or a carbonate or bicarbonate of an alkaline earth metal. It should be understood that the alkaline carbonate leach solution may contain addition anions, such as hydroxides and chlorides.

In one form of the present invention, the vanadium containing feed stream is an alkaline feedstock. It is envisaged that suitable feedstocks include slags, residues and other by-products of industrial processes. Throughout this specification, unless the context requires otherwise, the term “alkaline feedstock” will be understood to refer to feedstocks that comprise one or more alkali metal compounds and/or alkaline earth metal compounds or form an alkaline solution or slurry when mixed with water.

In one form of the present invention, the vanadium containing feed stream comprises a steel slag. Throughout this specification, unless the context requires otherwise, the term “steel slag” will be understood to refer to the slag byproduct of a steel manufacturing process. As would be appreciated by a person skilled in the art, when an iron containing material is exposed to high temperatures, at least some impurities or gangue material are separated from the molten metal and are removed as a slag. This slag is subsequently cooled, and a solid material is formed.

The method of the present invention is preferably adapted to leach residue that result from the alkaline carbonate leaching of slag materials that result from the steel industry. In addition to vanadium, such materials will contain iron, along with other species including, for example, calcium, manganese, titanium and chromium. The use of an alkaline carbonate leach solution allows for vanadium to be leached from such materials with high selectivity over other impurity metals.

In one form of the present invention, the alkaline carbonate leach solution comprises one or more of sodium carbonate (Na₂CO₃), sodium bicarbonate (NaHCO₃) and sodium hydroxide (NaOH). In one form of the present invention, the alkaline carbonate leach solution comprises one or more of potassium carbonate (K₂CO₃), potassium bicarbonate (KHCO₃) and potassium hydroxide (KOH). Any reference to sodium salts or species throughout the specification should be understood to be analogous to the use of potassium salts or species and any other alkali or alkaline earth carbonates and bicarbonates or mixtures thereof. As would be appreciated by a person skilled in the art, carbonates, bicarbonates and hydroxides exist together in aqueous solutions in a dynamic equilibrium in the leach solution during the leach step. In strongly basic conditions, the hydroxide and carbonate ion predominates, while in weakly basic conditions the bicarbonate ion is more prevalent.

In one form of the present invention, the alkaline carbonate leach solution comprises ammonium carbonate.

In one form of the present invention, the leach step is conducted under oxidative conditions.

In one form of the present invention, a carbon dioxide stream is injected into the leach step. Preferably, the carbon dioxide stream is used to control the pH of the leach step through the regeneration of carbonate or bicarbonate species. Alternatively, carbonic acid may be added to the leach step.

In one form of the present invention, at least a portion of the leach slurry is subjected to a size reduction step. In one form of the present invention, the size reduction step is conducted during the leach step. In an alternative form of the present invention, at least a portion of the leach slurry is transferred to a size reduction step to produce a process stream with a reduced particle size. In one form of the present invention, the process stream is returned to the leach step. In an alternative form of the present invention, the process stream is subjected to a secondary leach step.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flowsheet of the method of the present invention;

FIG. 2 is flowsheet of an alternative embodiment of the present invention which incorporates a magnetic separation step; and

FIG. 3 is a flowsheet of an alternative embodiment of the present invention which incorporates the use of resin in pulp.

### DESCRIPTION OF EMBODIMENTS

The method of the present invention relates to the recovery of vanadium from a vanadium containing leach residue. In a very broad sense, the method comprises the steps of:
subjecting the leach residue to a pulping step, the pulping step comprising the contact of the leach residue with an aqueous solution to produce a repulp slurry;
passing the repulp slurry to a solid liquid separation step to produce a repulp solution containing vanadium and a repulp residue; and
recovering vanadium from solution in an ion exchange step.

The method of the present invention is intended to recover residual vanadium and other soluble species that are contained within leach residues that result from hydrometallurgical processes. As would be appreciated by a person skilled in the art, hydrometallurgical processes involve a leach step in which an aqueous leachant is used to extract soluble metals from a feedstock into solution. The method of the present invention may be used in both acid and alkaline hydrometallurgical processes. Following the leach step, the pregnant leach solution is separated from the undissolved material, referred to as the leach residue. Separation typically involves the use of a filter to retain the solid residue on the filter as a filter cake. Whilst the majority of the soluble metals will pass through the filter and into the filtrate, a certain percentage of the soluble materials will remain entrained in the leach residue. To minimize losses, the filter cake is often washed on the filter multiple times in an attempt to recover any entrained soluble metal species. The inventors of the present invention have found that such wash circuits (for example on plate-and-frame filters) are typically only about 60-70% efficient with particularly low efficiencies associated with very fine particles and relatively low wash volumes. The loss of metals in the leach residue reduces overall metal recovery/production and revenue. The inventors have found that the method of the present invention would have best impact when the leach residue consists of very fine particles and contains residual soluble species that have simply been entrained in the solids or are only poorly soluble in the leach liquor.

The inventors of the present invention have identified that the method of the present invention is particularly useful for the recovery of soluble metal species from the leach residue resulting from a leach step comprising the contact of a feed stream with an alkaline carbonate leach solution. As would be appreciated by a person skilled in the art, alkaline carbonate leach solutions comprise alkali metal or alkaline earth metal carbonate/bicarbonate species. In preferred embodiments of the present invention, the alkaline carbonate leach solution comprises sodium species. The method of the present invention will allow for the recovery of the alkali/alkaline earth metal species. together with other soluble metal species that remain entrained in the leach residue. The recovered alkali/alkaline earth metal species can then be recycled or regenerated.

The method of present invention has been found to be suitable for use on leach residues that result from the leaching of alkaline feedstocks. Suitable alkaline feedstocks include slags, residues and/or other by-products of industrial processes. In a preferred embodiment, the alkaline feedstock is a slag material that results from the steel industry.

In a preferred embodiment of the present invention, the leach reside is obtained from the leaching of an alkaline feedstock with an alkaline carbonate leach solution. The inventors have found that an alkaline carbonate leach solution demonstrates good selectivity of vanadium over other metals that may be found in the feedstock. The method of the present invention has been found to be particularly useful in the recovery of vanadium from the leach residues that result from such leach processes. It is understood that such feedstocks typically comprise a high CaO and Ca(OH)₂ content. These species will react with carbonates in the leach solution to precipitate a number of different calcium carbonate species. Without wishing to be bound by theory, it is understood that dissolved vanadium may be entrained within the crystal structure of such species. In addition, mixed calcium/sodium carbonate species (such as Pirssonite, NazCa (CO₃)₂·2 (H₂O)) can be formed and these similarly have low solubility thus may remove a portion of the dissolved vanadium from solution during formation. The washing of such solids on the primary filter does not recover this vanadium. The inventors of the present invention believe that the pulping step of the present invention will reduce entrainment losses and re-dissolve at least a portion of these species, thereby recovering the entrained vanadium.

It has been found by the inventors that the method of the present invention may recover vanadium species in addition to the leached species entrained in the leach residue. Without wishing to be bound by theory, the inventors have found that sodium and mixed sodium/calcium carbonate species will precipitate in the leach residue. The pulping step of the present invention will dissolve these species, thereby facilitating the leaching of further vanadium species from the leach residue.

In one embodiment of the present invention, the method further comprises a leach step, the leach step comprising the contact of an alkaline feedstock with an alkaline carbonate leach solution to produce a primary leach solution and the leach residue.

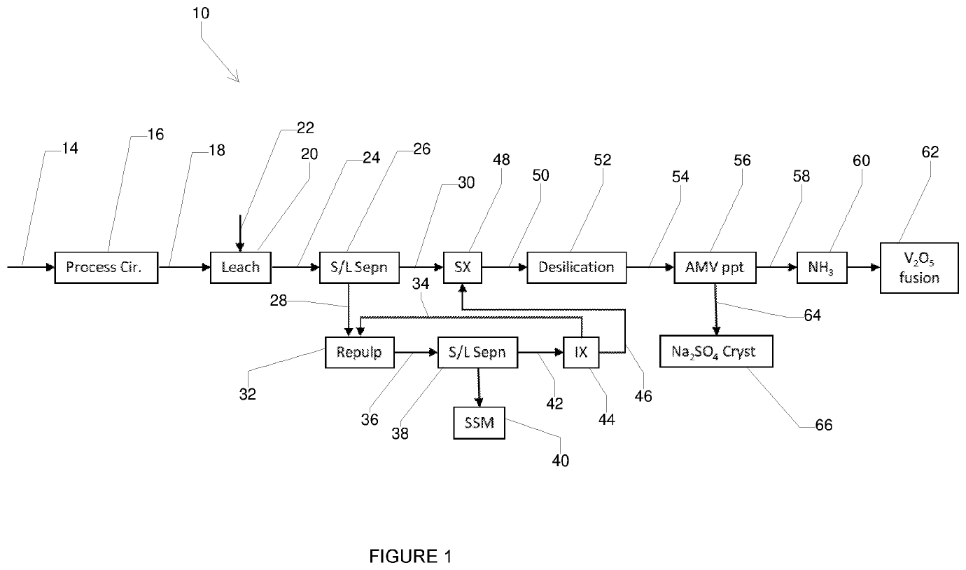

In FIG. 1, there is shown a method for the recovery of vanadium from a leach residue 10 in accordance with an embodiment of the present invention. In the embodiment shown in FIG. 1, a raw feedstock 14 is subjected to a processing circuit 16. It is envisaged that the processing circuit 16 may comprises one of more size reduction steps (not shown). It is envisaged that conventional crushing and grinding apparatus available to those skilled in the art can be used to reduce the particle size of the feedstock 14. It is envisaged that the processing circuit 16 may one or more beneficiation steps (not shown) to remove excess low value bearing components of the feedstock 14. The one or more beneficiation steps can include one or more of a gravity classification step, a magnetic classification step and a flotation step. In embodiments where the feed stock is a steel slag, the inventors have found that when sufficiently liberated a portion of the contained iron may be selectively removed by low intensity magnetic separation methods. The one or more size reduction steps have been found to liberate vanadium from such materials, allowing for subsequent dissolution in the leach step. It is envisaged that both wet and dry particle size reduction and beneficiation apparatus may be utilised.

The processed feed 18 is directed to a leach circuit 20 where it is contacted with a leach solution 22 in order to produce leach slurry 24. It is envisaged that a range of different feedstocks and leach solutions may be utilised in the leach circuit 20 in order to target one or more metals from the feedstock. The inventors have found that the method of the present invention is particularly useful for leach steps that target vanadium in steel slag feedstocks using an alkaline carbonate leach solution. A suitable leaching method is described in the Applicant's co-pending PCT/AU2020/051337, the contents of which are hereby incorporated herein by reference in their entirety. The following discussion is made in reference to a process for the leaching of vanadium from such feedstocks using a leach solution comprising sodium carbonate.

Following the leach processes the leach slurry 24 is directed to a solid liquid separation step 26 to separate out a leach residue 28 from a leach solution 30. The solid liquid separation step 26 may comprise one or more washing steps in which wash water is flushed through the leach residue filter cake 28 in order to recover any soluble metals that are retained in the leach residue 28. The wash filtrate, or part thereof, may then be recycled back to the leach circuit 20 or combined with the leach solution 30 to reduce metal losses. As discussed above, the inventors of the present invention have found that even after washing, the leach residue 28 can still contain soluble metals in residual entrained leach solution or in precipitated but weakly soluble species. Disposal of the leach residue 28 will result in the loss of such metal values. The method of the present invention seeks to recover at least some of these metals.

In the embodiment shown in FIG. 1, the leach residue 28 is directed to a pulping step 32 where it is contacted with an aqueous solution 34 to produce a repulp slurry 36. The pulping step 32 is used to remove any entrained soluble species within the leach residue 28 and recover at least a portion of these into solution. During the pulping step 32, the leach residue 28 particles will disperse through the aqueous solution, allowing any soluble species to redissolve into solution.

The use of a high liquid to solid ratio in the pulping step 32 has been found to allow for maximum recovery of soluble species from the primary leach residue 28. A higher liquid:solid ratio in the pulping step 32 assists with the dissolution of slowly dissolving species or species of low solubility. However, the increase in liquid:solid will increase the overall volume flow. This will increase the size of the equipment used in the ion exchange step. The inventors have found that the liquid:solid ratio should be controlled to ensure sufficient solubility, whilst also ensuring the overall volume flow is manageable. In one embodiment, the liquid:solid ratio in the pulping step is between 2:1 and 20:1. Preferably, the liquid:solid ratio in the pulping step is between 5:1 and 15:1. More preferably, the liquid:solid ratio in the pulping step is approximately 10:1.

In one embodiment, the temperature of the aqueous solution is above ambient temperature. Preferably, the temperature of the aqueous solution is at least 50° C. More preferably, the temperature of the aqueous solution is at least 60° C. The use of hot water has been generally found to speed up the re-dissolution of weakly soluble materials.

The repulp step 32 can be conducted in any suitable reactor vessel known to those skilled in the art. Preferably, the pulping step is conducted in an agitated reactor. The use of an agitated reactor has been found to assist with the breaking up and dispersion of the leach residue throughout the aqueous solution.

Where filtration is used in the primary solid liquid separation step 26, the leach residue 28 will be in the form of a filter cake. As would be appreciated by a person skilled in the art, filter cake is a bed of solid particles. To assist with the pulping step 32, the leach residue 28 may be subjected to a mechanical maceration process in order to break-up the leach residue 28 to assist with dispersion through the aqueous solution.

In one embodiment of the present invention, the leach residue 28 is subjected to a comminution step (not shown) prior to the pulping step 32. It is envisaged that any suitable crushing, milling, maceration or sizing apparatus can be used to in the comminution step. The material passing into the pulping step 28 is preferably passed through a sizing grate to prevent oversize material (lumps) entering the pulping step 32. Alternatively or additionally, the leach residue 28 is dropped from height onto the sizing grate or into the pulp reactor to break up the material.

The repulp slurry 36 is directed to a second solid liquid separation step 38 to remove a repulp residue 40 from a repulp solution 42. Wash water (not shown) is used in the solid liquid separation step 38 to ensure entrained liquids and soluble species are further reduced in the repulp residue 40. The high liquid to solid ratio in the pulping step 32 produces repulp slurry 36 with a relatively low concentration of soluble species. The inventors have found that the low concentration of soluble species in the repulp slurry 36 will result in a reduction in the fraction of less soluble species being retained by the solids in the solid liquid separation step 38. The solid residue stream 40 is preferably directed to tailings, waste disposal or other application. It is envisaged that the solid liquid separation step 38 will be conducted in a filtration apparatus, such as pressure filter or belt filter. Alternative solid liquid separation devices may be utilised in solid liquid separation step 38. In one embodiment, a counter-current washing process is used in the solid liquid separation step 38 in order to maximise vanadium recovery and optimise wash liquor volumes.

In one form of the present invention, the repulp slurry 36 is directed to a thickening step to produce a thickener overflow solution and a thickener underflow slurry. In one embodiment, the thickener overflow solution is directed to the pulping step 32 and the thickener underflow slurry is directed to the solid liquid separation step 38. In this embodiment, a substantial portion of the solution in repulp slurry 36 is removed prior to the solid liquid separation step 38. This has been found to reduce the volume of material directed to the solid liquid separation step 38 and the ion exchange step 44. This reduces the size of the equipment required in the solid liquid separation step 38 and the ion exchange step 44. The inventors have found that once the process reaches an equilibrium, the feed to the ion exchange step 44 will have an increased concentration of vanadium. In a preferred embodiment, the volume of the thickener underflow slurry is approximately 25 vol % of the repulp slurry. The thickening step will preferably increase to solids content of the repulp slurry from ˜10% to ˜35%.

The repulp solution 42 is likely to have relatively low concentration of value metals and in one embodiment of this process may be directed to an ion exchange step 44 in order to recover target metals from the solution. As discussed above, the low quantity of dissolved substance in the primary leach residue 28 and the high liquid:solid ratio in the pulping step 32, results in very low concentrations of soluble metals in the repulp solution. It is not economical to recycle the repulp solution back to the leach step 20 due to the need to dewater this solution. The inventors of the present invention have found that the ion exchange step 44 can be used to recover the soluble metals from the repulp solution. In the embodiment shown in FIG. 1, the repulp solution 42 is passed through one or more column(s) loaded with an ion exchange resin. The ion exchange step 44 will selectively extract the vanadium from the repulp solution 42 onto the ion exchange resin. Once the ion exchange resin is sufficiently loaded, it is contacted with an appropriate eluent in order to recover the target metals into a vanadium eluate solution 46. Where the target metal is vanadium, the eluent is preferably a sodium hydroxide solution. The ion exchange step allows the recovery of a concentrated vanadium solution that may be introduced into a vanadium production circuit.

Target metals are subsequently recovered from the vanadium eluate solution 46 by suitable methods known in the art. The particular method used will depend on the target metals and the eluent used. In the embodiment shown in FIG. 1, the primary leach solution 30 is directed to a solvent extraction circuit 48. In the solvent extraction circuit 48, the leach solution 30 is contacted with an organic extractant to extract vanadium ions from the aqueous phase into the loaded organic phase. The loaded organic phase may then be separated from the barren leach solution. The loaded organic can then be contacted with a scrub solution to displace entrained aqueous phase or weakly extracted impurities from the loaded organic. The loaded organic will then be contacted with an aqueous strip solution to recover vanadium from the loaded organic into a vanadium strip solution 50. In one embodiment, the vanadium eluate solution 46 recovered in the method of the present invention at least partially supplements the aqueous strip solution or the aqueous scrub solution used in the solvent extraction circuit 48. In this manner, the vanadium ions recovered from the primary leach residue 28 are returned to the primary circuit. Vanadium may then be recovered from the vanadium strip solution 50 by conventional means, such as for example precipitation, crystallisation or electrolysis. It is further envisaged that the vanadium eluate solution 46 recovered in the method of the present invention could be introduced into other stages of a hydrometallurgical vanadium recovery process, for example in the leach step.

In the embodiment shown in FIG. 1, the vanadium eluate solution 50 is directed to a desilication step 52 where it is contacted with an aluminium salt solution, for example aluminium sulphate to precipitate aluminium silicon compounds. Silicon removal may require pH adjustment and this is most readily achieved with a small quantity of sulphuric acid. The precipitated solids and any other insoluble materials are removed in a solid liquid separation step. The filtrate 54 is directed to a precipitation step 56 where it is contacted with ammonium sulphate to precipitate ammonium metavanadate. Sulphuric acid may be added to this precipitation step 56 to control solution pH for optimal vanadium recovery. A target pH of between 8-9 is preferred. The resulting slurry is directed to a filtration step. The filtered solids are washed with dilute ammonium sulphate solution to remove any entrained liquors and further purify the filter cake. The recovered solids 58 are directed to calcination step 60 for deammoniation and subsequent powder melting and production of solid V₂O₅ flakes 62 by methods familiar to those expert in the area. Barren liquor 64 from the precipitation step 56 is directed to a crystallisation step 66 to recover sodium sulphate crystals again by methods familiar to those expert in the area.

The barren solution 34 resulting from the ion exchange step 44 is recycled back to the pulping step 32 for use as the aqueous solution. Any dissolved metals not recovered in the ion exchange step 44 will also be recycled. In one form of the present invention, the method further comprises the step of recovering sodium from the repulp solution. Where an alkaline carbonate solution is used in the leach step 20, the primary leach residue 28 will also comprise alkaline metal cations, for example sodium. Such cations are not recovered in the ion exchange step 44 and the concentration of these species in the aqueous phase of the repulp circuit will increase. When the concentration has reached a suitable level, a portion of the aqueous solution can be bled from the aqueous solution 34 in order to recycle and reduce losses of these species. In one embodiment, the bleed stream may be directed to an evaporator to reduce the water content before being recycled. The bleed stream (or concentrated bleed stream) can be recycled to the leach step 20 where it supplements at least a portion of the alkaline carbonate leach liquor.

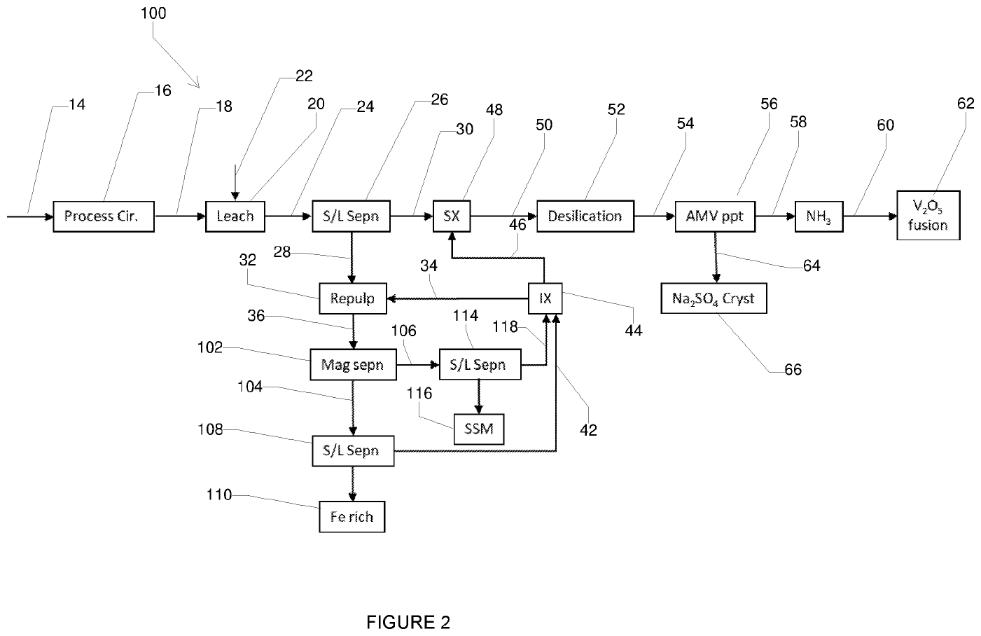

In FIG. 2, there is shown a method for the recovery of vanadium from a leach residue 100 in accordance with an embodiment of the present invention. The embodiment shown in FIG. 2 shares many similarities with the embodiment shown in FIG. 1 and like numerals denote like parts.

In the embodiment shown in FIG. 2, the leach residue 28 is directed to a pulping step 32 where it is contacted with an aqueous solution 34 to produce a repulp slurry 36. The pulping step 32 is used to remove any entrained soluble species within the leach residue 28 to recover at least a portion of these into solution. During the pulping step 32, the leach residue 28 particles will disperse through the aqueous solution, allowing any soluble species to redissolve into solution.

The pulping step 32 of the second embodiment of the present invention is substantially the same as the pulping step discussed above with respect to the first embodiment of the present invention.

The repulp slurry 36 is directed to a magnetic separation step 102 to separate a magnetic faction 104 from a non-magnetic (or less magnetic) fraction 106. The use of alkaline leach solutions in the leach step 20 has the advantage that iron species in the feedstock are not leached into solution. These iron species are therefore left in the leach residue 28 and will remain as solids in the repulp slurry 36. The inventors have found that the magnetic separation step 102 can be used to separate solids with a high iron content from the other solids, these solids may be recycled back to the steel making industry or find other applications. The magnetic separation step 102 utilises any suitable magnetic separation apparatus such as Low Intensity Magnetic Separators (LIMS).

The magnetic faction 104 is directed to a solid liquid separation step 108 to remove a magnetic repulp residue 110 from a repulp solution 112. Wash water (not shown) is used in the solid liquid separation step 108 to ensure the maximum entrained liquids and soluble species are separated from the magnetic repulp residue 110. It is envisaged that the solid liquid separation step 108 will be conducted in a filtration apparatus, such as belt filter. Alternative solid liquid separation devices may be utilised in solid liquid separation step 108. It is envisaged that a pre-filter thickener may also be used. In one embodiment, a counter-current washing process is used in the solid liquid separation step 108 in order to maximise vanadium recovery.

The non-magnetic fraction 106 is directed to a solid liquid separation step 114 to remove a non-magnetic repulp residue 116 from a repulp solution 118. Wash water (not shown) is used in the solid liquid separation step 114 to ensure the maximum entrained liquids and soluble species are separated from the non-magnetic repulp residue 116. It is envisaged that the solid liquid separation step 114 will be conducted in a filtration apparatus, such as belt filter. Alternative solid liquid separation devices may be utilised in solid liquid separation step 114. It is envisaged that a pre-filter thickener may also be used. In one embodiment, a counter-current washing process is used in the solid liquid separation step 114 in order to maximise vanadium recovery.

Each of the repulp solution 112 and repulp solution 118 contain vanadium and are subsequently directed to an ion exchange step to recover vanadium. In the embodiment shown in FIG. 2, repulp solution 112 and repulp solution 118 are combined into repulp solution 42. Repulp solution 42 is directed to ion exchange step 44 for recovery of vanadium. It is envisaged that repulp solution 112 and repulp solution 118 may be treated in the same or separate ion exchange steps to recover vanadium.

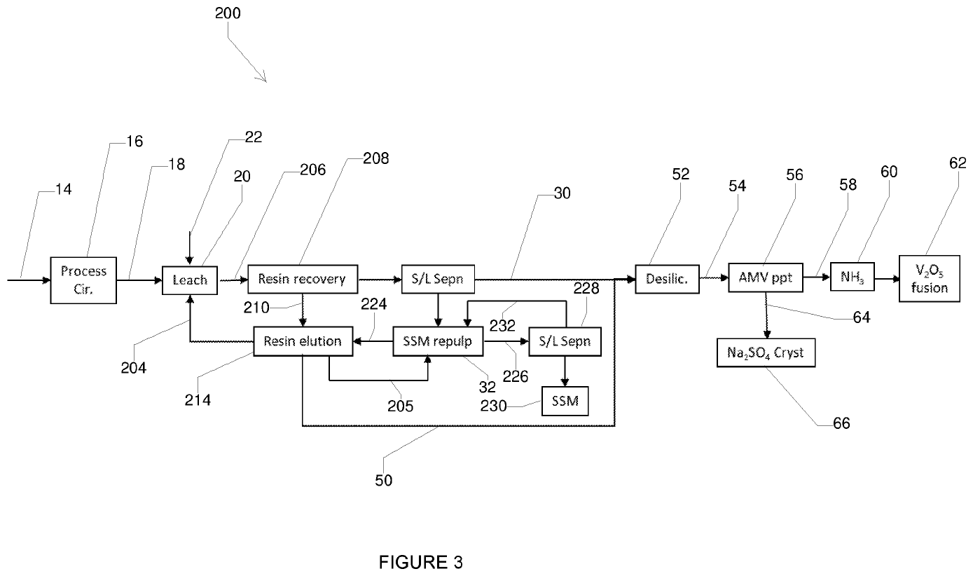

In FIG. 3, there is shown a method for the recovery of vanadium from a leach residue 200 in accordance with an embodiment of the present invention. The embodiment shown in FIG. 3 shares many similarities with the embodiment shown in FIG. 1 and like numerals denote like parts.

In the embodiment shown in FIG. 3, the processed feed 18 is directed to a leach circuit 20 where it is contacted with a leach solution 22 in order to produce a leach slurry. It is envisaged that a range of different feedstocks and leach solutions may be utilised in the leach circuit 20 in order to target one or more metals from the feedstock. The inventors have found that the method of the present invention is particularly useful for leach steps that target vanadium in steel slag feedstocks using an alkaline carbonate leach solution. A suitable leaching method is described in the Applicant's co-pending PCT/AU2020/051337, the contents of which are hereby incorporated herein by reference in their entirety. The following discussion is made in reference to a process for the leaching of vanadium from such feedstocks using a leach solution comprising sodium carbonate.

The resulting pregnant leach slurry is contacted with ion exchange resin 204, which selectively loads the vanadium, or other target metals from the pulp. This process is commonly referred to as a resin-in-pulp (RIP) and does not require separation of undissolved leach material prior to contact with the resin.

The resulting mixture 206 is directed to a resin recovery step 208, where the loaded resin 210 is separated from the metal depleted slurry 212 by screening. Multiple contact and screening steps may be employed to effect counter-current flow of leach slurry and ion exchange resin 204, thereby improving extraction efficiency. The loaded resin 210 is directed to a resin elution step 214 where it is contacted with a eluent to recover metals from the loaded resin 210 into a vanadium eluate solution 50. Following the recovery of vanadium, the ion exchange resin 204 is returned to the leach step 20. A portion of the ion exchange resin 205 is also directed to the pulping step 32 (as discussed below).

The metal-depleted (and resin-free) slurry 212 is directed to a solid liquid separation step 216 to separate out a leach residue 28 from a leach solution 30. The solid liquid separation step 216 may include one or more washing steps in which wash water is flushed through the leach residue 28 in order to recover any soluble metals that are retained in the leach residue 28. The wash filtrate may then be recycled back to the leach circuit 20 to prevent metal losses. As discussed above, the inventors of the present invention have found that even after washing, the leach residue 28 can still contain entrained soluble metals. Disposal of the leach residue 28 will result in the loss of such metal values. The method of the present invention seeks to recover at least some of these metals

In the embodiment shown in FIG. 3, the leach residue 28 is directed to a pulping step 32 where it is contacted with an aqueous solution 232 to produce a repulp slurry 226. The pulping step 32 is used to remove any entrained soluble species within the leach residue 28 to recover at least a portion of these into solution. During the pulping step 32, the leach residue 28 particles will disperse through the aqueous solution, allowing any soluble species to redissolve into solution.

The repulp slurry 36 is contacted with ion exchange resin 205, which selectively loads the vanadium, or other target metals from the pulp. This process is commonly referred to as a resin-in-pulp (RIP) and does not require separation of undissolved leach material prior to contact. Following contact, the loaded resin 224 is separated from the metal depleted slurry 226 by screening. The loaded resin 224 is directed to the resin elution step 214 where it is contacted with a eluate to recover metals from the loaded resin 224 into the vanadium eluate solution 50.

The metal-depleted slurry 226 is directed to a solid liquid separation step 228 to remove a repulp residue 230 from the aqueous solution 232. Wash water (not shown) is used in the solid liquid separation step 228 to ensure the maximum entrained liquids and soluble species are fully separated from the repulp residue 230. The solid residue stream is preferably directed to tailings or other application. It is envisaged that the solid liquid separation step 228 will be conducted in a filtration apparatus, such as belt filter. Alternative solid liquid separation devices may be utilised in solid liquid separation step 228. It is envisaged that a pre-filter thickener may also be used. In one embodiment, a counter-current washing process is used in the solid liquid separation step 228 in order to maximise vanadium recovery.

In one embodiment of the present invention, the liquid:solid ratio in the pulping step is between 2:1 and 20:1. Preferably, the liquid:solid ratio in the pulping step is between 5:1 and 15:1. More preferably, the liquid:solid ratio in the pulping step is approximately 10:1. The use of a high liquid to solid ratio in the pulping step 32 has been found to allow for maximum recovery of soluble species from the primary leach residue 28.

In the embodiment shown in FIG. 3, the leach solution 30 is combined with the vanadium eluate solution 50. In this manner, any vanadium ions that remain present in the primary leach solution 30 directed to the vanadium recovery circuit. Vanadium may then be recovered from the vanadium eluate solution 50 by conventional means, such as for example solvent extraction, precipitation, crystallisation or electrolysis.

In the embodiment shown in FIG. 3, the vanadium eluate solution 50 is combined with the leach solution 30 and directed to a desilication step 52 where it is contacted with an aluminium salt, for example aluminium sulphate to precipitate aluminium silicon compounds. Silicon removal may require pH adjustment and this is most readily achieved with a small quantity of sulphuric acid. The precipitated solids and other insoluble materials are removed in a solid liquid separation step. The filtrate 54 is directed to a precipitation step 56 where it is contacted with ammonium sulphate to precipitate ammonium metavanadate. Sulphuric acid may be added to precipitation step to control solution pH for optimal vanadium recovery. A target pH of between 8-9 is preferred. The resulting slurry is directed to a filtration step. The filtered solids are washed with dilute ammonium sulphate solution to remove any entrained liquors and further purify the filter cake. The recovered solids 58 are directed to calcination step 60 for deammoniation and subsequent powder melting and production of solid V₂O₅ flakes 62. Barren liquor 64 from the precipitation step 56 is directed to a crystallisation step 66 to recover sodium sulphate crystals.

### Example 1

A series of repulping tests were conducted on leach residues (SSM) obtained from the leaching of steel slags with a sodium carbonate solution. The tests involved taking samples of SSM that had already been washed on the filter and conducting four repulp wash tests under the following conditions:
i. Repulp at water:SSM of 10:1 at room temperature (JR009)
ii. Repulp at water:SSM of 10:1 at room temperature with an ion exchange (IX) resin in the slurry (JR010)
iii. Repulp at water:SSM of 10:1 at 50° C. (JR011)
iv. Repulp at water:SSM of 10:1 at 50° C. with an ion exchange (IX) resin in the slurry (JR012)

From a head of 0.44% V and 0.88% Na in feed SSM these tests led to the following vanadium recovered to wash water and residual vanadium in washed SSM levels:
i. ˜2% of the V and 28% of the Na in feed SSM in wash and unchanged % V and reduced % Na in washed SSM.
ii. ˜7% of the V recovered to resin and 30% of the Na in feed SSM in wash and reduced % V and reduced % Na in washed SSM.
iii. ˜3% of the V and 30% of the Na in feed SSM in wash and slightly reduced % V and reduced % Na in washed SSM.
iv. ˜10% of the V recovered to resin and 35% of the Na in feed SSM in wash and reduced % V and reduced % Na in washed SSM.

This work shows the need to do the repulp wash to remove vanadium and sodium from the SSM. Best results are obtained with warm water (higher temperatures were not considered due to economic considerations). The presence of resin removes soluble vanadium from the equilibria and appears to encourage the further dissolution of vanadium and sodium into water with higher temperatures again helping. The lowest levels of vanadium and sodium in washed SSM were reduced to 0.41% and 0.53% respectively.

### Example 2

Pilot plant processing of three different steel slags has been undertaken to process 25 kg of feed slag per hour. Three separate campaigns were run for between 6 and 12 days continuously operating for 24 hours per day.

In a first campaign, slag 1 was processed through the leach circuit including primary mill (targeting P80 of 75 microns), primary leach, primary regrind (targeting P80 of 20 microns), secondary leach, secondary regrind (targeting P80 of 10 microns) and tertiary leach. The initial leach feed was ˜30% solids and ˜100 g/L Na₂CO₃ at ˜70 deg C, while pH was held in the leach reactors at ˜10 using CO₂ sparger to convert hydroxide to carbonate at an appropriate rate. With the primary leach residence time of ˜6 hours and both the secondary and tertiary leach stages involving a residence time of ˜3 hours. The solids were then collected by batchwise filtration and washed in a three stage counter current manner with one bed volume of water. The solids were then repulped and stirred vigorously in hot water (˜90 deg C) for about 4 hours in 93 batches (˜64 kg per batch). The solids were then again collected by filtration and washed in a three stage counter current manner with warm water. Over the course of the trial, the vanadium tenor in the repulp solution varied between 0.18 and 0.68 g/L. A portion of the repulp solution was periodically processed through an ion exchange (IX) column to recover vanadium. During this campaign 48,000 L of repulp wash water was processed through the IX column in approximately 12 hour cycles. The average vanadium concentration in the IX feed was 0.31 g/L while the average vanadium concentration in IX barren was 0.12 g/L. The IX barren was recycled to the repulping step. The sodium tenor in the repulp solution varied between 5 and 7.6 g/L over the course of the trial. The sodium levels were managed through the use of a small bleed of the repulp solution being returned to the leach circuit. The campaign resulted in a further 3.9% of the vanadium in the slag feed being recovered.

In a second campaign, slag 2 was processed through the leach circuit including primary mill (targeting P80 of 75 microns), primary leach, primary regrind (targeting P80 of 20 microns), secondary leach, secondary regrind (targeting P80 of 10 microns) and tertiary leach. The initial leach feed was ˜30% solids and ˜100 g/L Na₂CO₃ at ˜70 deg C, while pH was held in the leach reactors at ˜10 using CO₂ sparger to convert hydroxide to carbonate at an appropriate rate. With the primary leach residence time of ˜6 hours and both the secondary and tertiary leach stages involving a residence time of ˜3 hours. The solids were then collected by batchwise filtration and washed in a three stage counter current manner with one bed volume of water. The solids were then repulped and stirred vigorously in hot water (˜90 deg C) for about 4 hours in 82 batches (˜62 kg per batch). The solids were then again collected by filtration and washed in a three stage counter current manner with warm water. Over the course of the trial, the vanadium tenor in the repulp solution varied between 0.25 and 0.50 g/L. A portion of the repulp solution was periodically processed through an ion exchange (IX) column to recover vanadium. During this campaign 46,000 L of repulp wash water was processed through the IX column in approximately 12 hour cycles. The average vanadium concentration in the IX feed was 0.30 g/L while the average vanadium concentration in IX barren was 0.14 g/L. The IX barren was recycled to the repulping step. The sodium tenor in the repulp solution varied between 6.3 and 8.2 g/L over the course of the trial. The sodium levels were managed through the use of a small bleed of the repulp solution being returned to the leach circuit. The campaign resulted in a further 4.8% of the vanadium in the slag feed being recovered.

In a third campaign, slag 3 was processed through the leach circuit including primary mill (targeting P80 of 75 microns), primary leach, primary regrind (targeting P80 of 20 microns), secondary leach, secondary regrind (targeting P80 of 10 microns) and tertiary leach. The initial leach feed was ˜30% solids and ˜100 g/L Na₂CO₃ at ˜70 deg C, while pH was held in the leach reactors at ˜10 using CO₂ sparger to convert hydroxide to carbonate at an appropriate rate. With the primary leach residence time of ˜6 hours and both the secondary and tertiary leach stages involving a residence time of ˜3 hours. The solids were then collected by batchwise filtration and washed in a three stage counter current manner with one bed volume of water. The solids were then repulped and stirred vigorously in hot water (˜90 deg C) for about 4 hours in 63 batches (˜64 kg per batch). The solids were then again collected by filtration and washed in a three stage counter current manner with warm water. Over the course of the trial, the vanadium tenor in the repulp solution varied between 0.17 and 0.35 g/L. A portion of the repulp solution was periodically processed through an ion exchange (IX) column to recover vanadium. During this campaign 33,000 L of repulp wash water was processed through the IX column in approximately 12 hour cycles. The average vanadium concentration in the IX feed was 0.27 g/L while the average vanadium concentration in IX barren was 0.09 g/L. The IX barren was recycled to the repulping step. The sodium tenor in the repulp solution varied between 5.6 and 7.7 g/L over the course of the trial. The sodium levels were managed through the use of a small bleed of the repulp solution being returned to the leach circuit. The campaign resulted in a further 5.2% of the vanadium in the slag feed being recovered.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

1. A method for the recovery of vanadium from a vanadium containing leach residue, the method comprising the steps of:
subjecting the leach residue to a pulping step, the pulping step comprising the contact of the leach residue with an aqueous solution to produce a repulp slurry;
passing the repulp slurry to a solid liquid separation step to produce a repulp solution containing vanadium and a repulp residue; and
recovering vanadium from solution in an ion exchange step.

2. A method according to claim 1, wherein the pulping step comprises agitation of the repulp slurry.

3. A method according to any one of the previous claims, wherein the ion exchange step is conducted following the solid liquid separation step.

4. A method according to any one of claim 1 or 2, wherein the ion exchange step is conducted prior to the solid liquid separation step.

5. A method according to any one of the previous claims, wherein the liquid:solid ratio in the pulping step is between 2:1 and 20:1.

6. A method according to any one of the previous claims, wherein the liquid:solid ratio in the pulping step is between 5:1 and 15:1.

7. A method according to any one of the previous claims, wherein the temperature of the aqueous solution is at least 60° C.

8. A method according to any one of the previous claims, wherein the repulp slurry is directed to a thickening step to produce a thickener overflow solution and a thickener underflow slurry and wherein the thickener overflow solution is directed to the pulping step and the thickener underflow slurry is directed to the solid liquid separation step.

9. A method according to any one of the previous claims, wherein the ion exchange step comprises contacting the repulp solution with an ion exchange resin to load vanadium onto the ion exchange resin and produce an effluent solution.

10. A method according to claim 9, wherein the effluent solution is directed to the pulping step.

11. A method according to claim 9 or 10, wherein the ion exchange step further comprises recovering vanadium from the loaded ion exchange resin by contact of the loaded ion exchange resin with an eluent to produce a vanadium eluate solution.

12. A method according to claim 11, wherein the method further comprises the recovery of a vanadium product from the vanadium eluate solution.

13. A method according to claim 12, wherein the step of recovering a vanadium product from the vanadium eluate solution comprises precipitating a vanadium rich solid and separating the vanadium rich solid from the barren solution.

14. A method according to claim 12, wherein the vanadium eluate solution is used as a stripping solution in a vanadium solvent extraction process.

15. A method according to any one of the previous claims, wherein the leach residue is obtained from a leach step comprising the contact of a vanadium containing feed stream with an alkaline carbonate leach solution.

16. A method according to claim 15, wherein the vanadium containing feed stream is an alkaline feedstock.
